(19) United States
(12) Patent Application Publication
(10) Pub. No.: US 2023/0286550 A1
(43) Pub. Date: Sep. 14, 2023

(54) SPOOF DETECTION FOR HANDS ON AUTOMATED DRIVING

(71) Applicant: GM GLOBAL TECHNOLOGY OPERATIONS LLC, Detroit, MI (US)

(72) Inventors: Mohammadali Shahriari, Markham (CA); Reza Zarringhalam, Whitby (CA); Ashraf Abualfellat, Grand Blanc, MI (US); Emily Frances Wolfangel, West Bloomfield, MI (US); Nathan Fujimoto, Scarborough (CA); Adam M. Mikalauskas, Livonia, MI (US)

(73) Assignee: GM GLOBAL TECHNOLOGY OPERATIONS LLC, Detroit, MI (US)

(21) Appl. No.: 17/654,103

(22) Filed: Mar. 9, 2022

(51) Int. Cl. B60W 60/00; B60W 40/09

(52) U.S. Cl. CPC B60W 60/0059; B60W 40/09; B60W 2540/30; B60W 2540/18; B60W 2420/24

(57) ABSTRACT

In accordance with an exemplary embodiment, a method is provided that includes: obtaining sensor data via one or more sensors of a vehicle; determining, via a processor of the vehicle, a driving style of a driver of the vehicle based on use of the sensor data over multiple periods of time; and determining, via the processor, an indication as to whether the driver is attempting to spoof a control system of the vehicle with respect to one or more automated features of the vehicle, based on the sensor data and the style of the driver.

### INTRODUCTION

The technical field generally relates to vehicles and, more specifically, to methods and systems for detecting a driver spoofing a vehicle with respect to an automated driving feature of the vehicle.

Certain vehicles today include functionality in which the vehicle automatically performs a function, but for which a level of alertness and/or participation is required for the driver. However, existing vehicles may not always detect when a driver is attempting to spoof the vehicle, for example by placing a weighted object on a steering wheel of the vehicle to provide a false indication of driver alertness and/or participation, and so on.

Accordingly, it is desirable to provide improved methods and systems for detecting when a driver is attempting to spoof a vehicle with respect to an automated driving feature of the vehicle. Furthermore, other desirable features and characteristics of the present disclosure will become apparent from the subsequent detailed description and the appended claims, taken in conjunction with the accompanying drawings and the foregoing technical field and background.

### SUMMARY

In accordance with an exemplary embodiment, a method is provided that includes: obtaining sensor data via one or more sensors of a vehicle; determining, via a processor of the vehicle, a driving style of a driver of the vehicle based on use of the sensor data over multiple periods of time; and determining, via the processor, an indication as to whether the driver is attempting to spoof a control system of the vehicle with respect to one or more automated features of the vehicle, based on the sensor data and the style of the driver.

Also in an exemplary embodiment, the driving style is determined via reinforcement learning performed by the processor using sensor data obtained over a plurality of different ignition cycles for the vehicle under a plurality of different conditions of a roadway and external environment surrounding the vehicle.

Also in an exemplary embodiment, the method further includes generating, via the processor, a spoof detection knowledge matrix using the sensor data obtained over the plurality of different ignition cycles for the vehicle under the plurality of different conditions of the roadway and external environment surrounding the vehicle, and incorporating the driving style and expected driver behavior under the plurality of different conditions.

Also in an exemplary embodiment, the spoof detection knowledge matrix is generated by the processor further based on knowledge of additional drivers' behavior under conditions that are similar to the plurality of different conditions.

Also in an exemplary embodiment, the indication as to whether the driver is attempting to spoof the control system is determined by the processor using the spoof detection knowledge matrix in combination with current values of the sensor data.

Also in an exemplary embodiment, the sensor data is representative of a driver's engagement of a steering wheel of the vehicle.

Also in an exemplary embodiment: the sensor data includes capacitive sensor data from one or more capacitive sensors of the vehicle as to the driver's contact with the steering wheel of the vehicle; the determining of the driving style is made by the processor using the capacitive sensor data; and the determining of the indication as to whether the driver is attempting to spoof the control system of the vehicle with respect to the one or more automated features of the vehicle is based on the capacitive sensor data and the style of the driver.

Also in an exemplary embodiment: the sensor data includes torque sensor data from one or more torque sensors of the vehicle as to the driver's contact with the steering wheel of the vehicle; the determining of the driving style is made by the processor using the torque sensor data; and the determining of the indication as to whether the driver is attempting to spoof the control system of the vehicle with respect to the one or more automated features of the vehicle is based on the torque sensor data and the style of the driver.

Also in an exemplary embodiment: the sensor data includes steering angle sensor data from one or more steering angle sensors of the vehicle as to a steering angle of the vehicle; the driver's contact with the steering wheel of the vehicle; the determining of the driving style is made by the processor using the steering angle sensor data; and the determining of the indication as to whether the driver is attempting to spoof the control system of the vehicle with respect to the one or more automated features of the vehicle is based on the steering angle sensor data and the style of the driver.

In another exemplary embodiment, a system is provided that includes one or more sensors and a processor. The one or more sensors are configured to obtain sensor data for a vehicle. The processor is configured to at least facilitate: determining a driving style of a driver of the vehicle based on use of the sensor data over multiple periods of time; and determining an indication as to whether the driver is attempting to spoof a control system of the vehicle with respect to one or more automated features of the vehicle, based on the sensor data and the style of the driver.

Also in an exemplary embodiment, the processor is further configured to determine the driving style via reinforcement learning performed by the processor using sensor data obtained over a plurality of different ignition cycles for the vehicle under a plurality of different conditions of a roadway and external environment surrounding the vehicle.

Also in an exemplary embodiment, the processor is further configured to generate a spoof detection knowledge matrix using the sensor data obtained over the plurality of different ignition cycles for the vehicle under the plurality of different conditions of the roadway and external environment surrounding the vehicle, and incorporating the driving style and expected driver behavior under the plurality of different conditions.

Also in an exemplary embodiment, the processor is further configured to generate the spoof detection knowledge matrix by the processor further based on knowledge of additional drivers' behavior under conditions that are similar to the plurality of different conditions.

Also in an exemplary embodiment, the processor is further configured to generate the indication as to whether the driver is attempting to spoof the control system using the spoof detection knowledge matrix in combination with current values of the sensor data.

Also in an exemplary embodiment, the sensor data is representative of a driver's engagement of a steering wheel of the vehicle.

Also in an exemplary embodiment: the one or more sensors include one or more capacitive sensors configured to generate capacitive sensor data as to the driver's contact with the steering wheel of the vehicle; and the processor is further configured to at least facilitate: determining the driving style using the capacitive sensor data; and determining the indication as to whether the driver is attempting to spoof the control system of the vehicle with respect to the one or more automated features of the vehicle based on the capacitive sensor data and the style of the driver.

Also in an exemplary embodiment, the one or more sensors include one or more torque sensors configured to generate torque sensor data as to the driver's contact with the steering wheel of the vehicle; and the processor is further configured to at least facilitate: determining the driving style using the torque sensor data; and determining the indication as to whether the driver is attempting to spoof the control system of the vehicle with respect to the one or more automated features of the vehicle based on the torque sensor data and the style of the driver.

Also in an exemplary embodiment, the one or more sensors include one or more steering angle sensors configured to generate steering angle sensor data as to a steering angle of the vehicle; and the processor is further configured to at least facilitate: determining the driving style using the steering angle sensor data; and determining the indication as to whether the driver is attempting to spoof the control system of the vehicle with respect to the one or more automated features of the vehicle based on the steering angle sensor data and the style of the driver.

In another exemplary embodiment, a vehicle is provided that includes a body and a control system for controlling one or more automated control systems for movement of the vehicle, including the body thereof. The control system includes one or more sensors and a processor. The one or more sensors are configured to obtain sensor data for the vehicle. The processor is configured to at least facilitate: determining a driving style of a driver of the vehicle based on use of the sensor data over multiple periods of time; and determining an indication as to whether the driver is attempting to spoof the control system with respect to one or more automated features of the vehicle, based on the sensor data and the style of the driver.

Also in one embodiment, the vehicle further includes a steering wheel; and the sensor data is representative of a driver's engagement of a steering wheel of the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for controlling one or more automated driving functions, and that detects when a driver is attempting to spoof the vehicle with respect to the automated driving functions, in accordance with exemplary embodiments;

FIG. 2 is a flowchart of process for detecting when a driver is attempting to spoof a vehicle with respect to an automated driving function, and that can be implemented in connection with the vehicle and control system of FIG. 1;

FIG. 3 is a flowchart of a portion of the process of FIG. 2, in accordance with an exemplary embodiment; and

FIGS. 4 and 5 depict exemplary implementations of the process of FIGS. 2 and 3, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

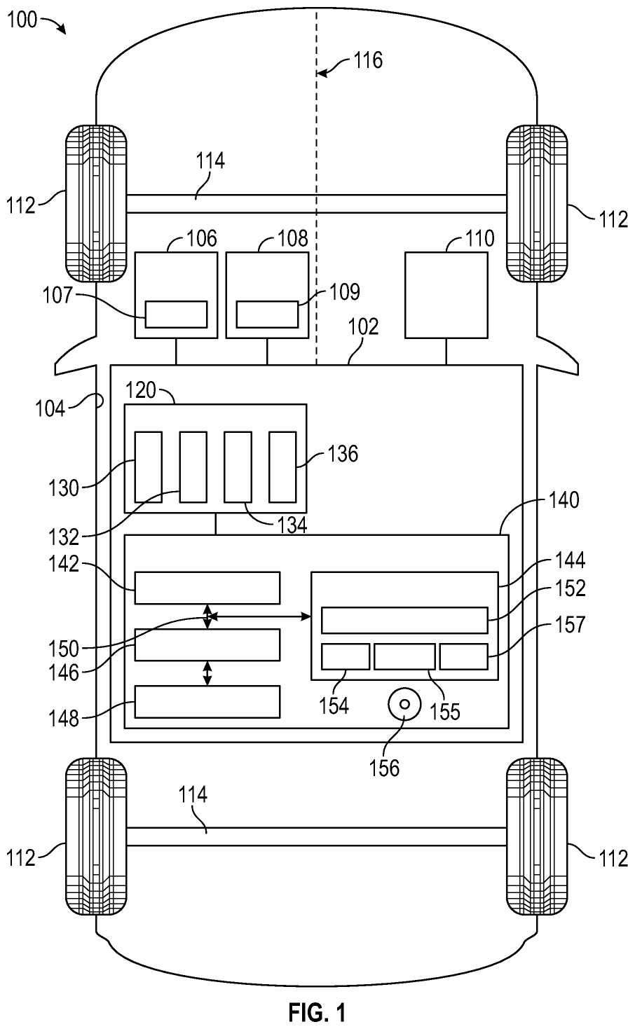

FIG. 1 illustrates a vehicle 100, according to an exemplary embodiment. As described in greater detail further below, the vehicle 100 includes a control system 102 that is configured for controlling one or more automatic driving features of the vehicle 100, including detecting when a driver is attempting to spoof the control system 102 with respect to the automatic driving features, in accordance with exemplary embodiments.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2 WD) (i.e., rear-wheel drive or front-wheel drive), four-wheel drive (4 WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. In certain embodiments, the drive system 110 comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver, such as a brake pedal 107 as depicted in FIG. 1, and in certain embodiments, also via automatic control via the control system 102. Also in exemplary embodiments, the steering system 108 controls steering of the vehicle 100 via steering components, such as a steering wheel 108 as depicted in FIG. 1 (e.g., in connection with a steering column coupled to the axles 114 and/or the wheels 112) that are controlled via inputs provided by a driver (e.g., via the steering wheel) 108), and in certain embodiments also via automatic control via the control system 102.

In the embodiment depicted in FIG. 1, the control system 102 is coupled to the steering system 108. In certain embodiments, the control system 102 may also be coupled to the braking system 106, the drive system 110, and/or one or more other vehicle systems and/or components. Also as depicted in FIG. 1, in various embodiments, the control system 102 includes a sensor array 120 and a controller 140.

In various embodiments, the sensor array 120 includes various sensors that obtain sensor data for use in controlling automatic functionality for the vehicle 100, as well as for use in detecting a driver's spoofing of the control system 102 with respect to the automatic functionality. In the depicted embodiment, the sensor array 120 includes one or more touch sensors 130, steering sensors 132, control sensors 134, and path sensors 136.

In certain embodiments, the touch sensors 130 include one or more capacitive sensors that are part of, attached to, or otherwise coupled to the steering wheel 109 and that are configured to measure an amount of force applied thereto. Also in certain embodiments, the steering sensors 132 are configured to measure a driver's interaction with the steering system 108 of the vehicle 100, including an amount of torque provided by the driver of the vehicle 100 to the steering wheel 109 and an angle at which the steering wheel 109 is engaged, and so on. In addition, in certain embodiments, the control sensors 134 measure control commands provided by the driver, for example in engaging the steering wheel 109, brake pedal 107, and/or the drive system 110 (e.g., an accelerator pedal thereof), and so on. Also in various embodiments, the path sensors 136 include one or more sensors that measure a path and/or movement of the vehicle 100, for example including one or more speed sensors, accelerometers, heading sensors, detection sensors such as radar, lidar, sonar, exterior cameras, and the like.

In various embodiments, the controller 140 is coupled to the sensor array 120 and receives sensor data therefrom. In various embodiments, the controller 140 controls automatic functionality for the vehicle 100, including functionality that requires a degree of driver alertness and/or participation (e.g., including lane keeping assist, lane centering, and other automated features), and including detecting of when a driver is attempting to spoof the control system 102 with respect to such automated functionality (e.g., when the driver has attached an object to the steering wheel to make it seem as though the driver has a hand on the steering wheel, and so on). In various embodiments, the controller 140 may also provide additional functionality for the vehicle 100, including for the steering system 108, the braking system 106, the drive system 110, and/or one or more other vehicle systems and/or components.

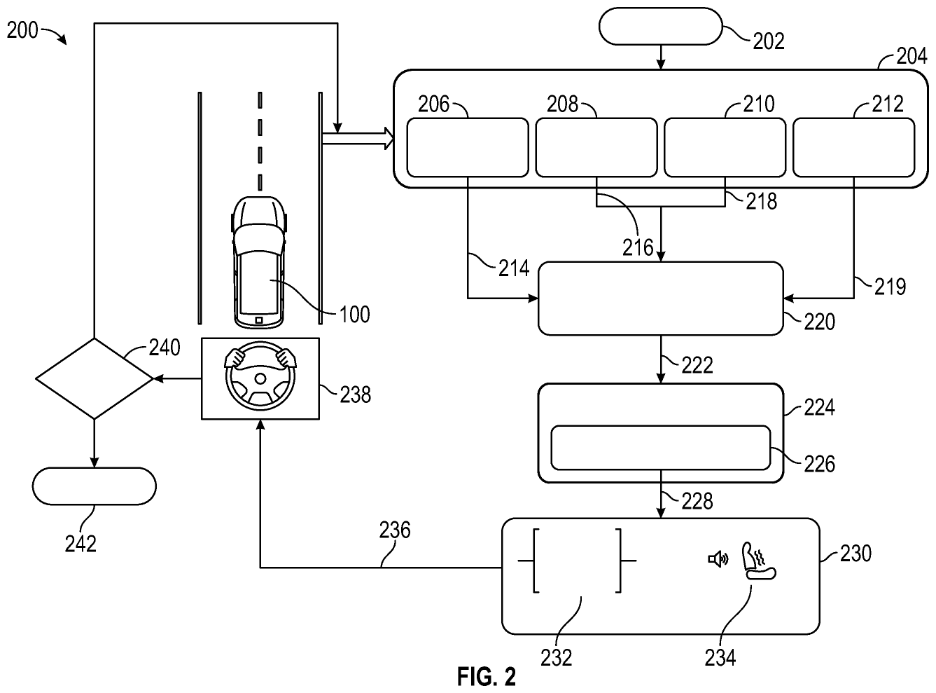

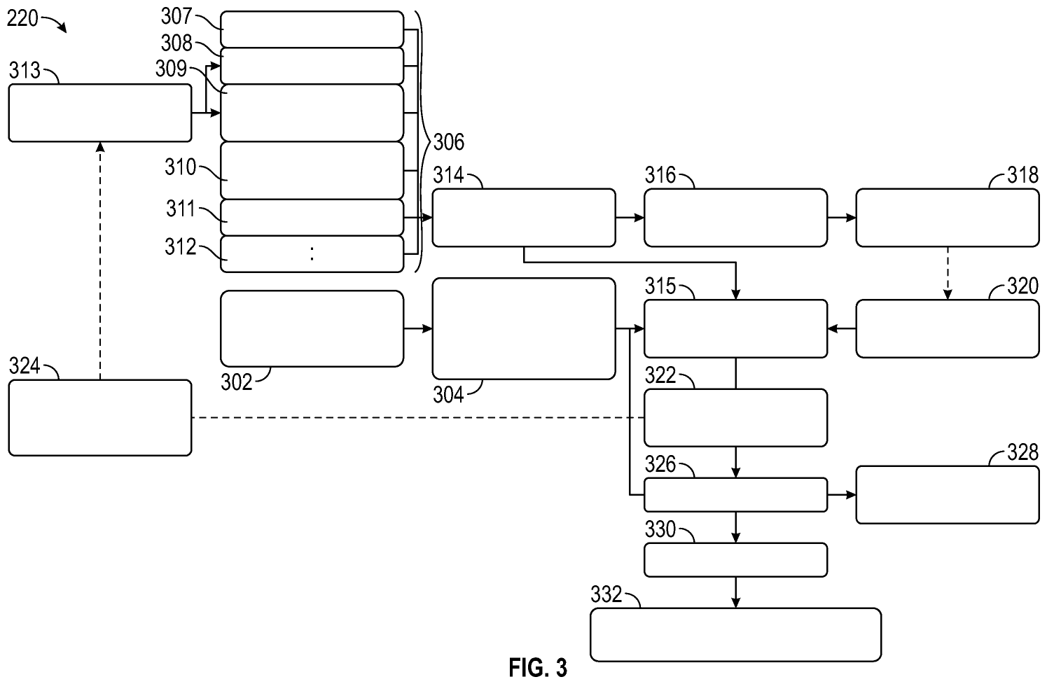

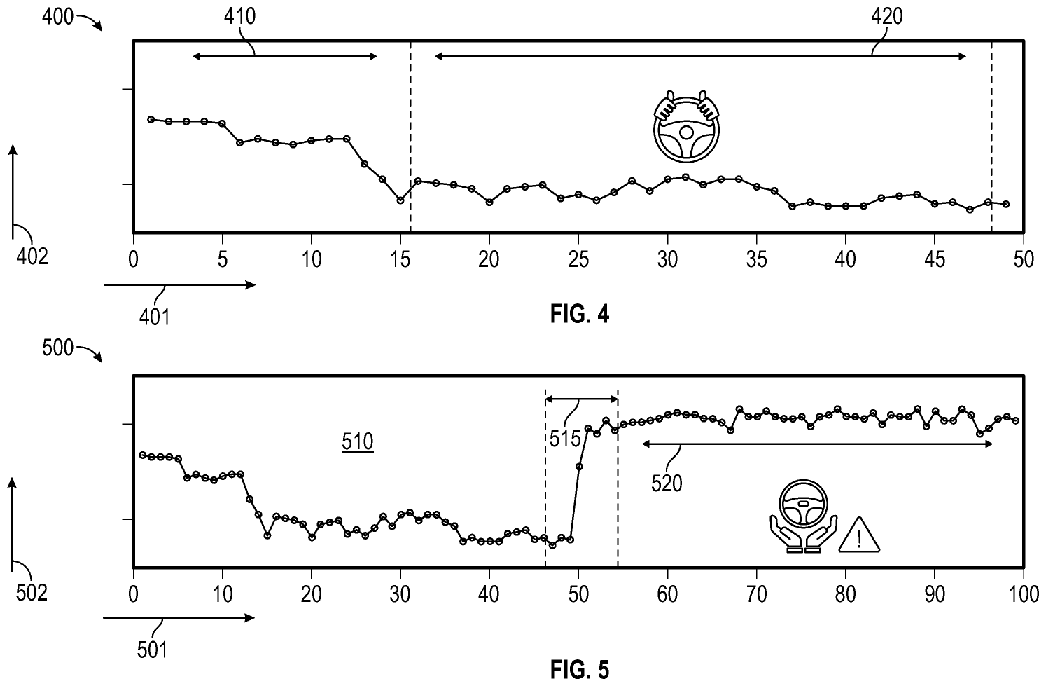

In various embodiments, the controller 140 comprises a computer system (also referred to herein as computer system 140), and includes a processor 142, a memory 144, an interface 146, a storage device 148, and a computer bus 150. In various embodiments, the controller (or computer system) 140 controls vehicle operation, including controlling automated vehicle functionality and detection of driver spoofing with respect to such automated functionality, among other vehicle control functions. In various embodiments, the controller 140 provides these and other functions in accordance with the steps of the process 200 of FIGS. 2 and 3 and the implementation of FIGS. 4 and 5, for example in connection with automated lane keeping, automated lane centering, and other automated control functionality for the vehicle 100.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIGS. 2 and 3 and the implementation of FIGS. 4 and 5 and described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with map data 154, one or more driver spoofing matrices 155 (e.g., historical data from automated learning regarding the driving habits and driving styles and characteristics of different drivers of the vehicle 100) and additional stored values 157 (e.g., look-up tables, thresholds, and/or other values with respect to detecting of spoofing, control of the automated vehicle control functions, and so on).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 of FIGS. 2 and 3 and the implementations of FIGS. 4 and 5 and described further below in connection therewith. In another exemplary embodiment, the program product may be directly stored in and/or otherwise accessed by the memory 144 and/or a disk (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIGS. 2 and 3 collectively provide a flowchart of process 200 for detecting when a driver is attempting to spoof a vehicle with respect to an automated driving function, in accordance with an exemplary embodiment. In various embodiments, the process 200 may be implemented in connection with the vehicle 100 and control system 102 of FIG. 1, and components thereof.

As depicted in FIG. 2, the process 200 begins at step 202. In one embodiment, the process 200 begins when a driver selects a lane centering feature for a vehicle. In certain embodiments, the process 200 may also begin when a vehicle drive or ignition cycle begins, for example when a driver approaches or enters the vehicle 100, or when the driver turns on the vehicle and/or an ignition therefor (e.g. by turning a key, engaging a keyfob or start button, and so on). In one embodiment, the steps of the process 200 are performed continuously during operation of the vehicle and/or during operation of the lane centering feature as selected by the driver.

Sensor data is obtained at step 204. In various embodiments, sensor data is obtained via each of the sensors of the vehicle's sensor array 120 of FIG. 1. In certain embodiments, the sensor data of step 204 includes the following: (i) capacitive touch sensor data 206 from the touch sensors 130 of FIG. 1 as to a driver's engagement of the steering wheel 109 of the vehicle 100 (e.g., as to whether or not one or both of the driver's hands are on the steering wheel 109); (ii) steering sensor data 208 from the steering sensors 132 of FIG. 1, such as from an electric power steering system (EPS) of the vehicle 100, including an amount of torque provided by the driver of the vehicle 100 to the steering wheel 109, a steering angle measurement at which the steering wheel 109 is engaged, and a control torque for the EPS; (iii) control sensor data 208 from the control sensors 134 of FIG. 1, including control commands provided by the driver in engaging the steering wheel 109, brake pedal 107, and/or the drive system 110 (e.g., an accelerator pedal thereof), and so on; and (iv) vehicle path sensor data 212 from the path sensors 136 of FIG. 1 as to a path, movement, and operation of the vehicle, for example including vehicle velocity, acceleration, yaw rate, and so on. In addition, in various embodiments, an identification of the driver is also received, for example via a detection of a fob, cell phone, and/or other device associated with the driver.

In various embodiments, respective inputs from the sensor data from step 204 are provided to the processor 142 of FIG. 1 for processing. For example, in various embodiments, the inputs include the following: (i) hands-on/hands-off detection 214 for the steering wheel 109 of FIG. 1, based on the capacitive touch sensor data 206; (ii) an amount of driver-applied torque 216, based on the steering sensor data 208; (iii) a control command 218 from the driver, based on the control sensor data 208; and (iv) vehicle yaw rate 219 (including “x” and “y” components for lateral and longitudinal yaw rates), based on the vehicle path sensor data 212. In addition, in various embodiments, an inputs as to the identification of the driver is also received.

In various embodiments, spoof detection is performed (step 220). In various embodiments, the spoof detection is performed by the processor 142 of FIG. 1. Specifically, in various embodiments, the processor 142 makes determinations as to whether the driver is spoofing, or tricking, the control system 102 of the vehicle 100 into believing, falsely, that the driver is engaging the steering wheel 109 of the vehicle 100 (e.g., by the driver attaching an object or some other weights to the steering wheel 109, and so on). In various embodiments, the processor 142 makes these determinations using the sensor data from the path sensors 136 of FIG. 1 and by performing a learning algorithm based on the driver's driving habits, style, and tendencies over time, and in various embodiments, over different periods of time during different vehicle drives (e.g., during different ignition cycles for the vehicle).

With reference to FIG. 3, a flowchart is provided with respect to the making of the spoofing determinations of step 220. Additional details of the spoofing determinations of step 220, and the learning algorithm techniques used therein, are provided in FIG. 3 and are discussed further below in connection therewith.

With reference back to FIG. 2, the spoofing determinations of step 220 result in a spoof detection percentage 222 as an output of step 220. In various embodiments, the processor 142 of FIG. 1 calculates the spoof detection percentage 222 based on a percentage likelihood that the driver is attempting to spoof the control system 102 (e.g., by placing a weight on the steering wheel 109, or the like), based on the use of the sensor data of step 204 in combination with the learning of the driver's behavior (including driving habits, style, and tendencies) over time.

In various embodiments, automated vehicle control functionality is initiated (step 224). In various embodiments, the processor 142 of FIG. 1 provides instructions for initiation of one or more automated vehicle control features for the vehicle 100. In certain embodiments, an automated lane keeping and/or automated lane centering functionality is initiated, among other possible automated vehicle control features.

Also in various embodiments, as the automated vehicle control functionality is initiated, an escalation determination is made with respect to driver behavior (step 226). Specifically, in various embodiments, the processor 142 of FIG. 1 determines whether escalation is appropriate based upon the spoof detection and determinations of step 220, and in various embodiments based on the spoof detection percentage 222. For example, in certain embodiments, a determination to initiate an escalation action protocol for ensuring driver alertness and/or participation may be made when the spoof detection percentage 222 exceeds a predetermined threshold that is stored in the memory 144 of FIG. 1 as a stored value 157 thereof. In one embodiment such a predetermined threshold may equal fifty percent (50%); however, this may vary in other embodiments. In various embodiments, an alert command 228 is provided by the processor 142 when it is determined that driver spoofing is likely (e.g., in certain embodiments, when the spoof detection percentage 222 exceeds the predetermined threshold).

Also in various embodiments, escalation actions are initiated at step 230 for ensuring that the driver is maintaining at least a predetermined measure of alertness and/or participation. Specifically, in various embodiments, when it is determined that driver spoofing is likely (e.g., in certain embodiments, when the spoof detection percentage 222 exceeds the predetermined threshold), one or more escalation actions are initiated based upon instructions provided by the processor 142. In certain embodiments, one or more visual messages 232 are provided for the driver, for example instructing the driver via a written message to “take steering”. Also in certain embodiments, one or more additional warnings 234 (e.g., one or me audio and/or haptic warnings 234) may also be initiated (e.g., audible chimes and/or vibrating of a driver seat, and so on).

In various embodiments, driver feedback is obtained at step 236. In various embodiments, during step 236, additional sensor data is obtained from the sensors of the sensor array 120 of FIG. 1 as to the driver's response to the escalation actions of step 230. For example, in certain embodiments, the sensors of the sensor array 120 receive inputs 238 from the driver as to the driver's engagement (or re-engagement) of the steering wheel, and so on. In one such embodiment, one or touch sensors 130 (e.g., one or more capacitive touch sensor of or coupled to the steering wheel) of FIG. 1 are utilized for receiving such sensor data/inputs. In various embodiments, if it is determined that the driver has not reacted sufficiently such as to evidence driver alertness and/or participation (e.g., if the driver has not placed one or more hands on the steering wheel, in one embodiment), then further escalation may occur. For example, in certain embodiments, the initial warning may be a visual notification, a second escalated warning (if the driver is still not deemed to be attentive after an initial period of time) may include an audible and/or haptic warning, and a third escalation (if the driver is still not deemed to be attentive after a subsequent additional period of time) may include disabling the automated vehicle control feature (e.g., disabling the feature for the reminder of the vehicle driver and/or until the driver shows alertness and/or participation), and so on.

In various embodiments, a determination is made at step 240 as to whether the process is to continue. In various embodiments, this determination is made by the processor 142 of FIG. 1 as to whether a current vehicle drive (e.g., a current vehicle ignition cycle) is still occurring and/or whether the lane centering feature and/or other automated feature of the vehicle as selected by the driver is still in operation. In various embodiments, if it is determined that the process is to continue (e.g., if the automated feature is still in operation), then the process returns to step 204, and sensor data continues to be collected in a new iteration. In various embodiments, steps 204-240 thereafter repeat in this manner in various iterations until a determination is made in an iteration of step 240 that the process is complete (e.g., that a current vehicle drive is complete), after which the process terminates (step 242).

With reference to FIG. 3, a flowchart is provided with a more detailed explanation of step 220 (spoof determination) in accordance with an exemplary embodiment. As illustrated in FIG. 3, in various embodiments, inputs 306 are obtained. In certain embodiments, the inputs 306 are obtained from an electric power steering system (EPS) 313 of the vehicle 100, for example corresponding to the steering system 108 of FIG. 1. In certain embodiments, the inputs 306 correspond to the sensor data and corresponding inputs of step 204 as described above in connection with FIG. 2. In addition, in certain embodiments, the inputs 306 may include event (e.g., contact) camera and perception system inputs 307, touch sensor inputs 308 (e.g., respect to the steering wheel of the vehicle), torque capacitor inputs 309 (e.g., including changes in static torque ratio), control error inputs 310 (e.g., corresponding to measures of control errors versus driver inputs), pose inputs 311 (e.g., as to a pose of the driver), and/or any number of other inputs 312. In addition, in various embodiments, an identification of the driver is also received, for example via a detection of a fob, cell phone, one or more driver monitoring systems, and/or other device associated with the driver.

In various embodiments, a state classification is performed (step 314). In various embodiments, the processor 142 of FIG. 1 provides a classification as to various road and environmental factors pertaining to the vehicle 100 based on determinations pertaining to the road and environmental factors. For example, in various embodiments, the classification pertains to driver actions (such as a driver's touching of the steering wheel, the driver's torque applied to the steering wheel, an angle in which the driver has positioned the steering wheel, the driver's pose, and so on), in addition to vehicle parameters as to movement of the vehicle 100 (e.g., velocity, lateral and longitudinal acceleration and yaw rates, and so on), as well as to the roadway and environmental factors (e.g., including whether the roadway is straight or curved, whether the roadway is relatively flat or inclined, whether or not the road represents a highway or freeway, weather conditions, traffic conditions, detected vehicles or other objects on or near the roadway, and so on).

In various embodiments, the classification of states is utilized in determining a level of attentiveness for the driver, and for learning about the driver's driving style, tendencies, and habits over time for subsequent use in determining over time whether the driver is spoofing the control system 102. In certain embodiments, the driver attentiveness is represented by the following equation:

Aᵢ=π(Q, Sᵢ) (Equation 1),

in which “A,” represents an aggregate attentiveness score for the driver, “π” represents a policy algorithm (and/or function) for determining the aggregate attentiveness score using inputs “Q” and “s”, wherein “Q” represents the learned knowledge scores for different factors (e.g., each based on specific individual sensor data values and state) through the learning procedure (it can also contain prepopulated prior knowledge), and wherein “s” represents various parameters of the state classification of step 314.

In various embodiments, the individual attentiveness scores “a” are characterized by the following equation:

Aᵢ=[a2, . . . , am] (Equation 2),

in which “a₁” represents the lowest possible attentiveness score, “aₘ” represents the highest possible attentiveness score, and so on.

In certain embodiments, during step 314, the state classification values “s” may be represented in accordance with the following equation:

Sᵢ=[ΔQ_{str,i}, τ_{D,i}, τ_{ctr,i}, S_{curv,i}, v_{x,i}] (Equation 3),

in which “Sᵢ” represents a classification for a particular state factor “i”; “ΔQ_{str,i}” represents a change in touch capacitor output, “S_{curv,i}” represents a measure of curvature of the roadway on which the vehicle is travelling, and “v_{x,i}” represents a velocity of the vehicle. “τ_{D,I}” represents a measure of driver's applied torque on the steering wheel, “τ_{ctr,I}”, represents a requested control torque command to the steering system by automated driving system.

In various embodiments, during steps 316-320, expected driver behaviors are determined based on the state classifications of step 314. In various embodiments, during steps 316-320, the processor 142 of FIG. 1 determines an expected behavior of the driver with respect to the driver's engagement of the steering wheel (e.g., holding of the steering wheel with one or more fingers and/or one or both hands, an amount of torque applied to the steering wheel, the steering wheel angle, and changes to any and all of the above) based on the various factors of the state classification of step 314 (e.g., including vehicle parameters as to movement of the vehicle 100 such as velocity, lateral and longitudinal acceleration and yaw rates, and so on), in addition to additional factors as to the roadway and the external environmental to the vehicle 100, such as whether the roadway is straight or curved, whether the roadway is relatively flat or inclined, whether or not the road represents a highway or freeway, weather conditions, traffic conditions, detected vehicles or other objects on or near the roadway, and so on). For example, in various embodiments, if the driver usually drives in a particular manner (e.g., with one hand versus two hands, and/or with a certain number of fingers, and/or with different styles or different roadways and environmental conditions), this will be captured and implemented as part of the process 200.

Also in various embodiments, the expected driver behaviors are determined using a reinforcement learning algorithm that is executed by the processor 142 of FIG. 1, and that includes a policy function (step 316), an action function (step 318), and a reward function (step 320) as part of the expected driver behavior determinations of steps 316-320. In various embodiments, the expected driver behavior determinations provide an output that includes a reward function for the expected driver behavior in accordance with the following equation:

R(a,s)=−k_1|τ_{d}−τ_{c}|+k_2*sgn(k_3−|τ_{d}−τ_{c}|) (Equation 4),

in which “R(Aᵢ, Sᵢ)” represents the reward function that explicitly quantifies how driver is reactive to the environment. Other forms of this equations can be written to quantify driver's attentiveness measure. k_1, k_2, k_3>0 represent design parameters, “sgn” represents the sign function.

In various embodiments, a spoof detection knowledge matrix is generated (step 315). In various embodiments, the processor 142 of FIG. 1 generates the spoof detection knowledge matrix using the state classifications of steps 314 along with the expected driver behavior determinations of steps 316-320 (including the reward function and results of step 320). In various embodiments, in generating the spoof detection knowledge matrix, the processor 142 also utilizes sensor data as to the driver behavior, including the driver's engagement of the steering wheel (in certain embodiments, this may already be included in the state classification of step 314).

Also in various embodiments, in generating the spoof detection knowledge matrix, the processor 142 also utilizes prior knowledge generated in steps 302 and 304, described directly below. In certain embodiments, during step 302, prior knowledge is obtained based on known use cases, for example based on average or standard driver actions across a number of different drivers (e.g., not related to the vehicle 100), either in terms of general or baseline values or tailored to situations similar to those present in the state classification of step 314. Also in certain embodiments, during step 304, additional prior knowledge is obtained with respect to prior behavior of the current driver that is presently operating the vehicle 100 (e.g., including prior instances and situations in which the current driver may have attempted to spoof the system, and so on). In addition, in certain embodiments, general criteria and/or indications of driver spoofing may also be obtained from a stored database, for example as to expected levels of variations in a driver's contact with and/or torque provided to the steering wheel in general based on whether the driver is actually engaging the steering wheel with his or her hand versus a “spoofing” activity in which a fixed weight or other object is attached to the steering wheel (e.g., more variability in contact and/or torque may be expected when the driver is actually engaging the steering wheel, and so on). In certain embodiments, steps 302 and 304 may be performed “offline” (e.g., prior to the other steps of the process 200 and/or prior to the current vehicle driver and/or prior to the execution of the current iteration of the process 200).

In various embodiments, the spoof detection knowledge matrix is generated via the processor 142 of FIG. 1 using computer processor-implemented machine learning, including deep reinforcement learning, including based on the step described above. In various embodiments, the spoof detection knowledge matrix is stored in the memory 144 of FIG. 1, specifically as the matrix 155 therein as depicted in FIG. 1. In various embodiments, the spoof detection knowledge matrix is utilized in current and subsequent iterations of the process 200 (e.g., including within current and subsequent vehicle drives) in determining whether a driver is attempting to spoof the control system 102 with respect to automated functionality for the vehicle 100, for example in accordance with the following “Q Matrix” provided below:

$$\begin{matrix}\begin{matrix}{s}_{1} & … & {s}_{n}\end{matrix} \\ Q = \begin{matrix}{a}_{1} \\ ⋮ \\ {a}_{m}\end{matrix} [ \begin{matrix}{Q}_{11} & … & {Q}_{n 1} \\ ⋮ & ⋱ & ⋮ \\ {Q}_{1 m} & … & {Q}_{nm}\end{matrix} ]\end{matrix}$$

In various embodiments, the spoof detection knowledge matrix is utilized to determine whether the current driver is attempting to spoof the control system (step 322). In various embodiments, the processor 142 of FIG. 1 compares the sensor data and state classification of 307-314 with the spoof detection knowledge matrix of step 320 in determining whether the driver is attempting to spoof the control system 102 of FIG. 1.

In various embodiments, the processor 142 assigns a probability or percentage likelihood that the driver is believed to be attempting to spoof the control system 102 (e.g., by placing a weight or other object on the steering wheel, and so on) based on the current sensor data and classifications as compared with the spoof detection knowledge matrix. Accordingly, in various embodiments, the probability or percentage likelihood is thus based on a comparison of the driver's current behavior versus the driver's expected behavior and the driver's actual past behavior in similar circumstance (e.g., under similar roadway conditions and external conditions, and so on).

For example, in various embodiments, if a particular driver generally applies a certain amount of torque to the steering wheel and/or generally changes the hand positions and/or torque applied to the steering wheel under certain circumstances (and/or if other drivers have done so under similar circumstances) but does not do so in the future under similar circumstances, then the driver may not be believed to be likely attempting to spoof the system. In addition, if the driver is currently engaging behavior that was previously associated with driver spoofing (e.g., by the current driver and/or other drivers), then this may similarly lead to a conclusion that the driver may be attempting to spoof the system, and so on.

In various embodiments, the spoofing determinations of step 322 (including the probability and/or spoof detection percentage pertaining thereto) are utilized in steps 220-224 of FIG. 2, and as at of the spoof detection percentage 222 of FIG. 2, as described above in connection with FIG. 2.

Also in various embodiments, these determinations of step 322 may also be used to adjust thresholds for escalation actions for the driver with respect to driver spoofing (step 324). For example, if a particular driver develops a history of spoof attempts, then escalation actions for automated vehicle control functionality (e.g., as described above in connection with steps 224-236 of FIG. 2) may be implemented and/or escalated more quickly, and so on. In various embodiments, the adjusted thresholds of step 324 may be utilized in future iterations of the steps of FIG. 3 as well as in current and future iterations of steps 222-336 of FIG. 2.

In addition, in various embodiments, the results of the driver spoofing determinations are associated with a particular identification of the driver (step 326), as well as one or more additional driver attentiveness scores (step 328), driving styles (step 330), and escalation configurations (step 332) for the particular driver, and automated driving controls adaptation to navigate the vehicle safely. In various embodiments, these adjustments may be similar to those described above, and may also be incorporated into the spoof detection knowledge matrix of step 315 and the driver spoofing determinations of step 322, among other steps of the process 200 as depicted in FIGS. 2 and 3.

FIGS. 4 and 5 depict exemplary implementations of the process 200 of FIGS. 2 and 3, in accordance with exemplary embodiments. Specifically: (i) FIG. 4 depicts a first illustration in which the process 200 is implemented in connection with a first driver that is not attempting to spoof the system; whereas (ii) FIG. 5 depicts a second illustration in which the process 200 is implemented in connection with a second driver that is attempting to spoof the system.

With respect to the first implementation of FIG. 4, a first graphical representation is provided that includes an “x” axis 401 representing time (e.g., in seconds or milliseconds, in certain embodiments), and that further includes a “y” axis 402 representing a probably of spoofing by the driver (e.g., in percentage terms, in certain embodiment). As depicted in FIG. 4, in this particular implementation, a learning phase 410 is utilized in building information as to the driving behavior of the driver of the vehicle 100. Also as depicted in FIG. 4, in this particular embodiment, during an implementation phase 420 following the learning phase 410, it is determined that spoofing is not likely to be occurring (e.g., because the driver's behavior is consistent with prior driver behavior in which spoofing was not evident).

With respect the second first implementation of FIG. 5, a second graphical representation is provided that includes an “x” axis 501 representing time (e.g., in seconds or milliseconds, in certain embodiments), and that further includes a “y” axis 502 representing a probably of spoofing by the driver (e.g., in percentage terms, in certain embodiment). As depicted in FIG. 5, in this particular implementation, a learning phase 510 is utilized in building information as to the driving behavior of the driver of the vehicle 100. Also as depicted in FIG. 5, in this particular embodiment, during implementation phases 515 and 520 following the learning phase 510, it is determined that spoofing is not likely to be occurring (e.g., because the driver's behavior is either (a) inconsistent with prior driver behavior in which spoofing was not evident or (b) consistent with prior driver behavior in which spoofing was evident). As depicted in FIG. 5, in various embodiments, in situations in which spoofing is detected, the implementation phases may include an initial portion (515) in which spoofing is initially suspected and a subsequent portion (520) in which spoofing is confirmed.

Accordingly, methods, systems, and vehicles are provided for determining whether a driver is attempting to spoof, or trick, a vehicle system with respect to automated vehicle control functionality. In various embodiments, computer learning algorithms are utilized to build knowledge regarding the driving behavior of the current driver (and, in certain embodiments, other drivers as well) under various conditions, and a spoofing knowledge matrix is generated. In various embodiments, sensor data is utilized to generate a classification of current states of the vehicle, roadway, and environment with respect to the current vehicle drive, and the sensor data (and classifications and determinations pertaining thereto) are utilized in combination with the spoofing knowledge matrix in order to determine when the driver is attempting to spoof the system with respect to the automated vehicle control functionality. In various embodiments, when it is determined that spoofing is likely to be occurring by the driver, the vehicle control system implements one or more escalation actions and/or protocols in order to help assure that the driver maintains a required level of attentiveness.

Thus, in various embodiments, the disclosed systems, vehicles, and methods intelligently detect and quantify if a driver is spoofing the system. Moreover, the disclosed systems, vehicles, and methods are tailored to the particular driver. For example, in various embodiments, if the driver usually drives in a particular manner (e.g., with one hand versus two hands, and/or with a certain number of fingers, and/or with different styles and characteristics or different roadways and environmental conditions), this will be captured and implemented as well. In various embodiments, the disclosed systems, vehicles, and methods provide a systematic, computer processor-implemented mathematical solution to learn driving style for different drivers and different driving conditions, in analyzing how the driver is expected to operate the vehicle, and using this information in combination with real-time sensor data in assessing a likelihood that a particular driver is attempting to spoof the automated vehicle control system under specific conditions and environments.

It will be appreciated that the systems, vehicles, and methods may vary from those depicted in the Figures and described herein. For example, the vehicle 100 of FIG. 1, the control system 102 thereof, and/or components thereof of FIG. 1 may vary in different embodiments. It will similarly be appreciated that the steps of the process 200 may differ from that depicted in FIGS. 2 and 3, and/or that various steps of the process 200 may occur concurrently and/or in a different order than that depicted in FIGS. 2 and 3. It will similarly be appreciated that the implementations of FIGS. 4 and 5 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining sensor data via one or more sensors of a vehicle;
determining, via a processor of the vehicle, a driving style of a driver of the vehicle based on use of the sensor data over multiple periods of time; and
determining, via the processor, an indication as to whether the driver is attempting to spoof a control system of the vehicle with respect to one or more automated features of the vehicle, based on the sensor data and the style of the driver.

2. The method of claim 1, wherein the driving style is determined via reinforcement learning performed by the processor using sensor data obtained over a plurality of different ignition cycles for the vehicle under a plurality of different conditions of a roadway and external environment surrounding the vehicle.

3. The method of claim 2, further comprising:
generating, via the processor, a spoof detection knowledge matrix using the sensor data obtained over the plurality of different ignition cycles for the vehicle under the plurality of different conditions of the roadway and external environment surrounding the vehicle, and incorporating the driving style and expected driver behavior under the plurality of different conditions.

4. The method of claim 3, wherein the spoof detection knowledge matrix is generated by the processor further based on knowledge of additional drivers' behavior under conditions that are similar to the plurality of different conditions.

5. The method of claim 3, wherein the indication as to whether the driver is attempting to spoof the control system is determined by the processor using the spoof detection knowledge matrix in combination with current values of the sensor data.

6. The method of claim 1, wherein the sensor data is representative of a driver's engagement of a steering wheel of the vehicle.

7. The method of claim 6, wherein:
the sensor data includes capacitive sensor data from one or more capacitive sensors of the vehicle as to the driver's contact with the steering wheel of the vehicle;
the determining of the driving style is made by the processor using the capacitive sensor data; and
the determining of the indication as to whether the driver is attempting to spoof the control system of the vehicle with respect to the one or more automated features of the vehicle is based on the capacitive sensor data and the style of the driver.

8. The method of claim 6, wherein:
the sensor data includes torque sensor data from one or more torque sensors of the vehicle as to the driver's contact with the steering wheel of the vehicle;
the determining of the driving style is made by the processor using the torque sensor data; and
the determining of the indication as to whether the driver is attempting to spoof the control system of the vehicle with respect to the one or more automated features of the vehicle is based on the torque sensor data and the style of the driver.

9. The method of claim 6, wherein:
the sensor data includes steering angle sensor data from one or more steering angle sensors of the vehicle as to a steering angle of the vehicle; the driver's contact with the steering wheel of the vehicle;
the determining of the driving style is made by the processor using the steering angle sensor data; and
the determining of the indication as to whether the driver is attempting to spoof the control system of the vehicle with respect to the one or more automated features of the vehicle is based on the steering angle sensor data and the style of the driver.

10. A system comprising:
one or more sensors configured to obtain sensor data for a vehicle; and
a processor configured to at least facilitate:
determining a driving style of a driver of the vehicle based on use of the sensor data over multiple periods of time; and
determining an indication as to whether the driver is attempting to spoof a control system of the vehicle with respect to one or more automated features of the vehicle, based on the sensor data and the style of the driver.

11. The system of claim 10, wherein the processor is further configured to determine the driving style via reinforcement learning performed by the processor using sensor data obtained over a plurality of different ignition cycles for the vehicle under a plurality of different conditions of a roadway and external environment surrounding the vehicle.

12. The system of claim 11, wherein the processor is further configured to generate a spoof detection knowledge matrix using the sensor data obtained over the plurality of different ignition cycles for the vehicle under the plurality of different conditions of the roadway and external environment surrounding the vehicle, and incorporating the driving style and expected driver behavior under the plurality of different conditions.

13. The system of claim 12, wherein the processor is further configured to generate the spoof detection knowledge matrix by the processor further based on knowledge of additional drivers' behavior under conditions that are similar to the plurality of different conditions.

14. The system of claim 12, wherein the processor is further configured to generate the indication as to whether the driver is attempting to spoof the control system using the spoof detection knowledge matrix in combination with current values of the sensor data.

15. The system of claim 10, wherein the sensor data is representative of a driver's engagement of a steering wheel of the vehicle.

16. The system of claim 15, wherein:
the one or more sensors comprise one or more capacitive sensors configured to generate capacitive sensor data as to the driver's contact with the steering wheel of the vehicle; and
the processor is further configured to at least facilitate:
determining the driving style using the capacitive sensor data; and
determining the indication as to whether the driver is attempting to spoof the control system of the vehicle with respect to the one or more automated features of the vehicle based on the capacitive sensor data and the style of the driver.

17. The system of claim 15, wherein:
the one or more sensors comprise one or more torque sensors configured to generate torque sensor data as to the driver's contact with the steering wheel of the vehicle; and
the processor is further configured to at least facilitate:
determining the driving style using the torque sensor data; and
determining the indication as to whether the driver is attempting to spoof the control system of the vehicle with respect to the one or more automated features of the vehicle based on the torque sensor data and the style of the driver.

18. The system of claim 15, wherein:
the one or more sensors comprise one or more steering angle sensors configured to generate steering angle sensor data as to a steering angle of the vehicle; and
the processor is further configured to at least facilitate:
determining the driving style using the steering angle sensor data; and
determining the indication as to whether the driver is attempting to spoof the control system of the vehicle with respect to the one or more automated features of the vehicle based on the steering angle sensor data and the style of the driver.

19. A vehicle comprising:
a body; and
a control system for controlling one or more automated control systems for movement of the vehicle, including the body thereof, the control system comprising:
one or more sensors configured to obtain sensor data for the vehicle; and
a processor configured to at least facilitate:
determining a driving style of a driver of the vehicle based on use of the sensor data over multiple periods of time; and
determining an indication as to whether the driver is attempting to spoof the control system with respect to one or more automated features of the vehicle, based on the sensor data and the style of the driver.

20. The vehicle of claim 19, wherein:
the vehicle further includes a steering wheel; and
the sensor data is representative of a driver's engagement of a steering wheel of the vehicle.
